(19) United States
(12) Patent Application Publication
(10) Pub. No.: US 2011/0161993 A1
(43) Pub. Date: Jun. 30, 2011

(54) DISK DEVICE

(76) Inventors: Akinori Tsukaguchi, Tokyo (JP); Tatsunori Fujiwara, Tokyo (JP); Takaharu Eguchi, Tokyo (JP); Akihito Onishi, Tokyo (JP); Yoshifumi Awakura, Tokyo (JP)

(21) Appl. No.: 13/060,590

(22) PCT Filed: Sep. 25, 2009
(86) PCT No.: PCT/JP2009/004857

§ 371 Date: Feb. 24, 2011

(30) Foreign Application Priority Data
Nov. 17, 2008 (JP) 2008-293380

(51) Int. Cl. G11B 17/04

(52) U.S. Cl. 720/645; G9B/17.013

(57) ABSTRACT

A disk device includes: a disk detecting member 17 pushed and moved by a disk; a rotation body 20 driven by the movement of the disk detecting member 17 to move a slide member 11; a tubular body 23 provided coaxially on the surface of the rotation body 20 and having an axially cutaway section; and an arm section 24 provided on the slide member 11 and abutted against the peripheral surface of the tubular body to cause the moving force exerted on the slide member 11 to act on the center of the rotation body 20.

### TECHNICAL FIELD

The present invention relates to a disk device that switches the modes of a disk loading stand-by state and a disk playback state by the movement of a slide member.

### BACKGROUND ART

In this type of disk device, as shown in FIG. 13 and FIG. 14, a disk detecting member 101 is pivotally supported to be rotatable on a board 103 about a shaft 102 at the middle portion thereof. A pin 101a against which the peripheral surface of a disk abuts is provided on the top face on the side of one end of the disk detecting member 101, and the end face on the side of the other end thereof abuts against the rear end of a driving force transmitting member 104. The driving force transmitting member 104 is urged in the direction opposite to an arrow by an urging member (not shown).

A rotation body 105 and a drive gear 106 are provided on the board 103, the rotation body 105 has a tooth-lacking gear 105a for meshing with the drive gear 106, and a pin 107 is provided on the face of the gear such that the pin is situated on the travel line of the driving force transmitting member 104 in a disk loading stand-by state. A slide member 108 driven by the rotation body 105 is forwardly and rearwardly movably provided on a side (not shown) of the board 103. Further, a shoulder 108a against which a disk clamp member 109 abuts is formed on the top face of the slide member 108, while a guide groove 108b for vertically moving a disk conveying roller and an arm section 108c having a length extending inside the rotational track of the pin 107 are formed on the inner face thereof.

In the disk loading stand-by state as shown in FIG. 13, when a disk 114 is loaded, the disk 114 pushes and moves the disk detecting member 101 through the pin 101a. For this reason, the disk detecting member 101 pushes and moves the driving force transmitting member 104 in the direction of an arrow, and the rotation body 105 is rotated by the movement of the driving force transmitting member 104 through the pin 107. A tooth-lacking section 105b is moved off from the opposed position by the rotation of the rotation body 105, the tooth-lacking gear 105a meshes with the drive gear 106, and thereafter the rotation body 105 continues rotating by the driving force from the drive gear 106.

By the rotation of the rotation body 105, the pin 107 on the top face of the rotation body 105 moves the slide member 108 in the direction of an arrow through the arm section 108c. For this reason, as the disk 114 is carried to be located on a turntable (not shown) , a disk conveying roller is, with a shaft thereof moved downwardly along the guide groove 108b, moved to a position where a contact with the disk 114 is avoided. Further, simultaneously, a disk clamp member 109 abutting against the top face of the slide member 108 is snapped down onto the shoulder 108a to press and hold the disk 114 on the turntable, thus achieving a disk playback or reproducing condition as shown in FIG. 14.

Since a conventional disk device is arranged as discussed above, for example, if some shock is given in a disk loading stand-by state to displace the slide member 108, the modes may be switched from the disk loading stand-by state to the disk playback state. However, it is necessary that the switch of the modes be surely made only when it is intended; thus, the switch thereof when not intended is a problem.

Thus, a disk device contrived so as not to make such a problem is disclosed in Patent Document 1. The disk device disclosed in Patent Document 1 is arranged as follows: a fastening base for supporting a moving member is provided with an abutting section and a limiting section; when a moving means is located on the side of the limiting section, further a conveying means is located in a conveying force transmitting position, and a movable arm for supporting a conveying roller is rotating counterclockwise, if the moving member is moved in the opposite direction of the limiting section, the movable arm is rotated clockwise by the abutting section provided on the fastening base, and a projection of the movable arm is limited by the limiting section, thus restraining the movable arm from counterclockwise rotating.

### Prior Art Documents

### Patent Documents

Patent Document 1: JP-A-2003-346407

### SUMMARY OF THE INVENTION

However, the disk device disclosed in Patent Document 1 is arranged, as discussed above, such that the movable arm for supporting the conveying roller is provided with the projection, and the fastening base for supporting the moving member is provided with the abutting section and the limiting section, resulting in a complicated structure; thus, there is a problem such that it is difficult to surely restrain an impact force due to vibrations or the like.

The present invention has been accomplished to solve the above-discussed problem, and an object of the present invention is to provide a disk device with a simple structure that can prevent positively an inconvenience such that a slide member is displaced by an impact force because of vibrations or the like, which can cause an accidental switching the modes of a disk loading stand-by state and a disk playback state.

The disk device according to the present invention includes: a disk detecting member to be pushed and moved by a disk; a rotation body to be driven by the movement of the disk detecting member to move the slide member; a tubular body provided coaxially on the surface of the rotation body and having an axially cutaway section; and an arm section provided on the slide member to cause a moving force exerted on the slide member to act on the center of the rotation body when abutted against the peripheral surface of the tubular body.

According to the present invention, it is arranged that the disk device includes: the rotation body to be driven by the disk detecting member to move the slide member; the tubular body provided coaxially on the surface of the rotation body and having an axially cutaway section; and the arm section provided on the slide member and causing the moving force exerted on the slide member to act on the center of the rotation body when abutted against the peripheral surface of the tubular body. Thus, as long as the rotation body does not rotate, the moving force exerted on the slide member acts from the arm section toward the center of the rotation body through the tubular body. As a result, even if the impact force due to vibrations or the like is exerted on the slide member, the disk device with a simple structure can positively prevent an event switching the modes from the disk loading stand-by state to the disk playback state because of an accidental movement of the slide member; further, even if an impact force is exerted thereon, the operation is not switched by virtue of no rotation of the rotation body to maintain the disk loading stand-by state.

### DESCRIPTION OF THE DRAWINGS

FIG. 1 is an exploded perspective view of a disk playback device in accordance with a first embodiment of the present invention.

FIG. 2 is a plan view of main parts thereof before a disk is loaded.

FIG. 3 is a perspective view showing a playback unit in a loading state of the disk.

FIG. 4 is a right-hand side view of the playback unit.

FIG. 5 is a side view showing the unit with a slide member removed therefrom in FIG. 4.

FIG. 6 is a perspective view of the main parts thereof showing a state where a loaded disk is abutted against a disk detecting member.

FIG. 7 is an enlarged plan view of FIG. 6.

FIG. 8 is a perspective view of the main parts thereof showing a state where a disk is loaded in a predetermined position.

FIG. 9 is a perspective view showing the playback unit in a state where the disk loading is completed.

FIG. 10 is a right-hand side view of the playback unit.

FIG. 11 is a side view showing the unit with a slide member removed therefrom in FIG. 10.

FIG. 12 is a front view showing the slide member viewed from the inside of the unit along the line A-A of FIG. 3.

FIG. 13 is a perspective view showing a drive unit of a conventional slide member.

FIG. 14 is a perspective view showing a state where the slide member is being moved.

### BEST MODE FOR CARRYING OUT THE INVENTION

Embodiments of the present invention will now be described with reference to the accompanying drawings in order to explain the present invention in more detail.

### First Embodiment

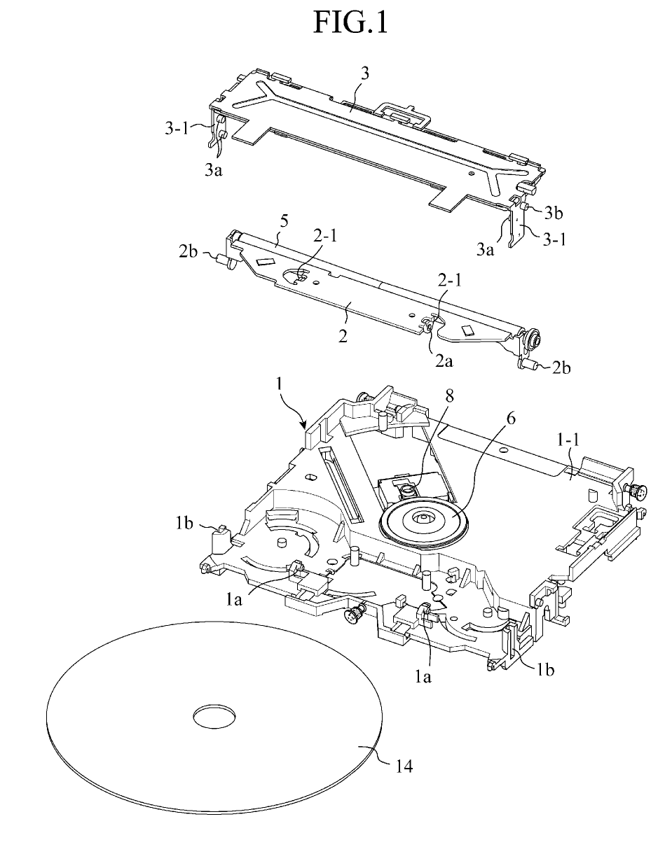

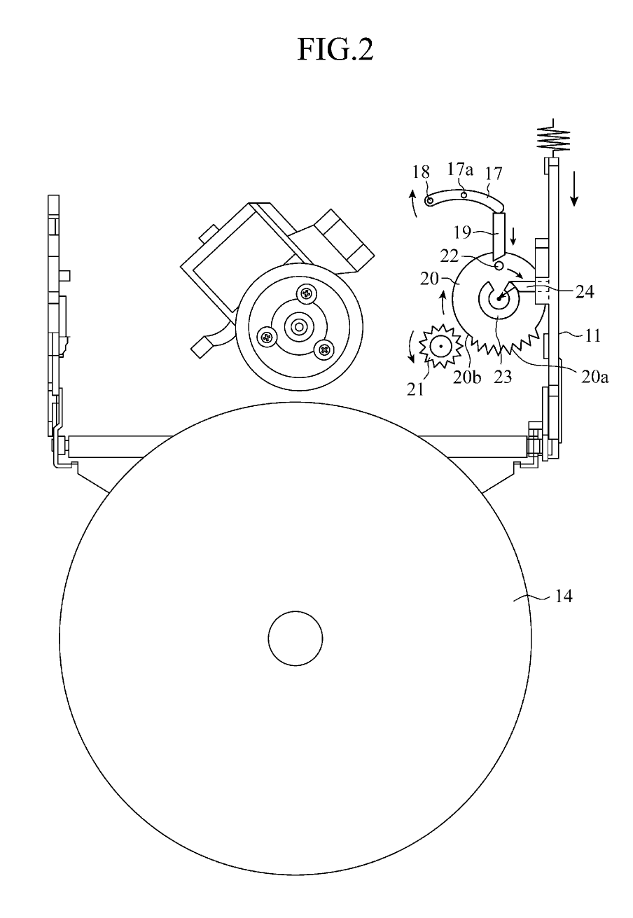

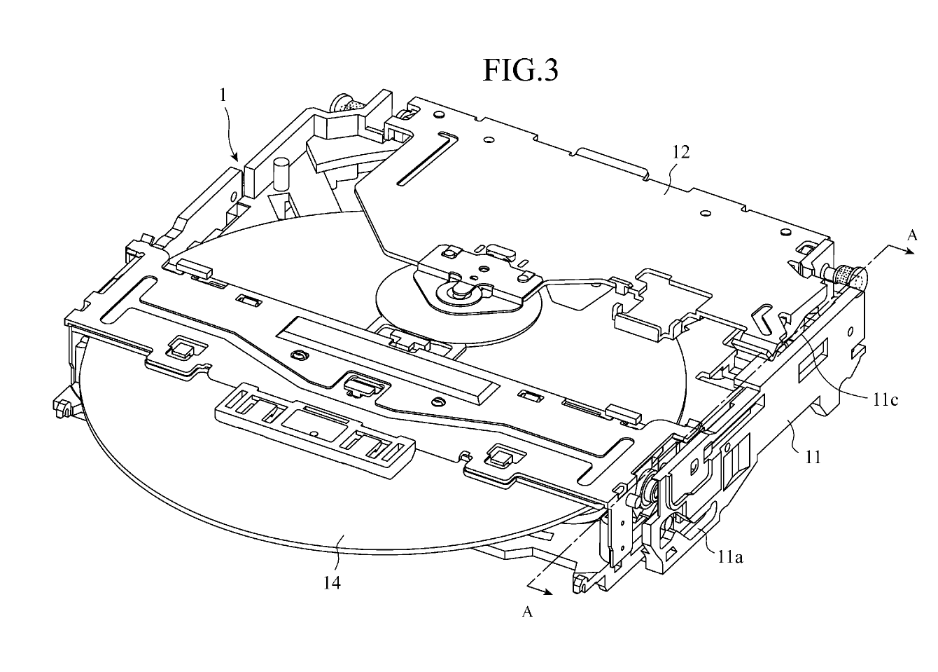

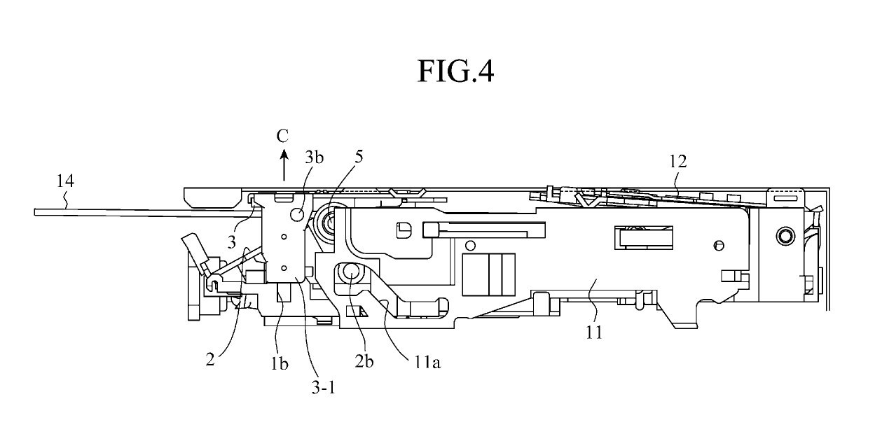

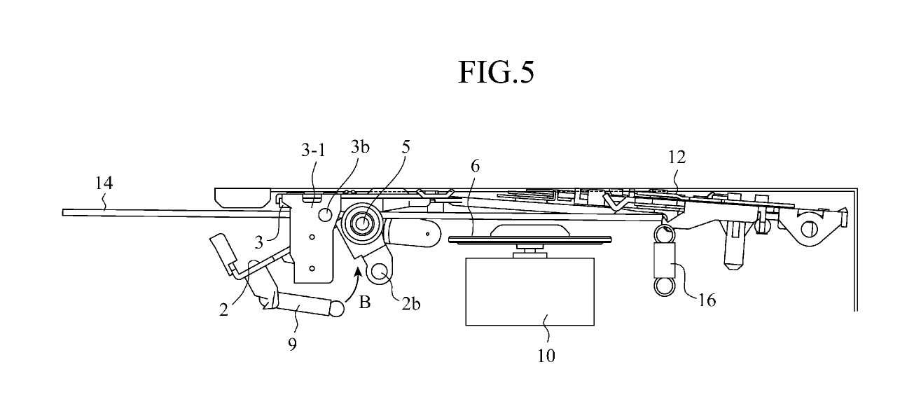

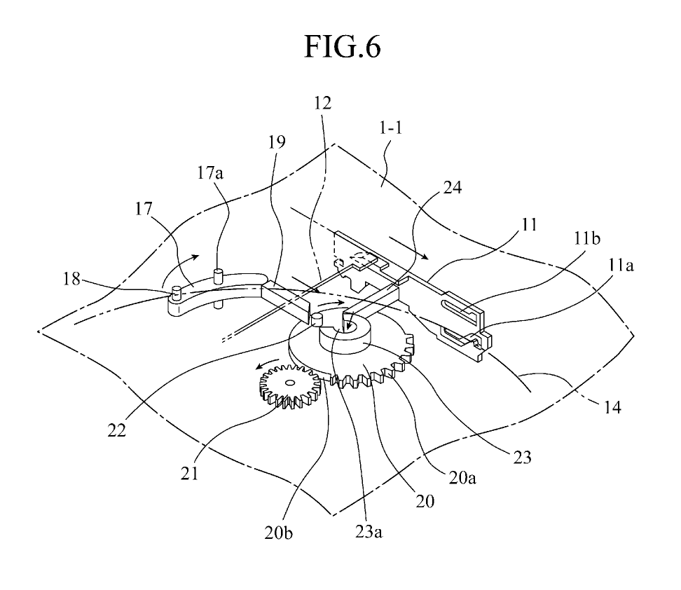

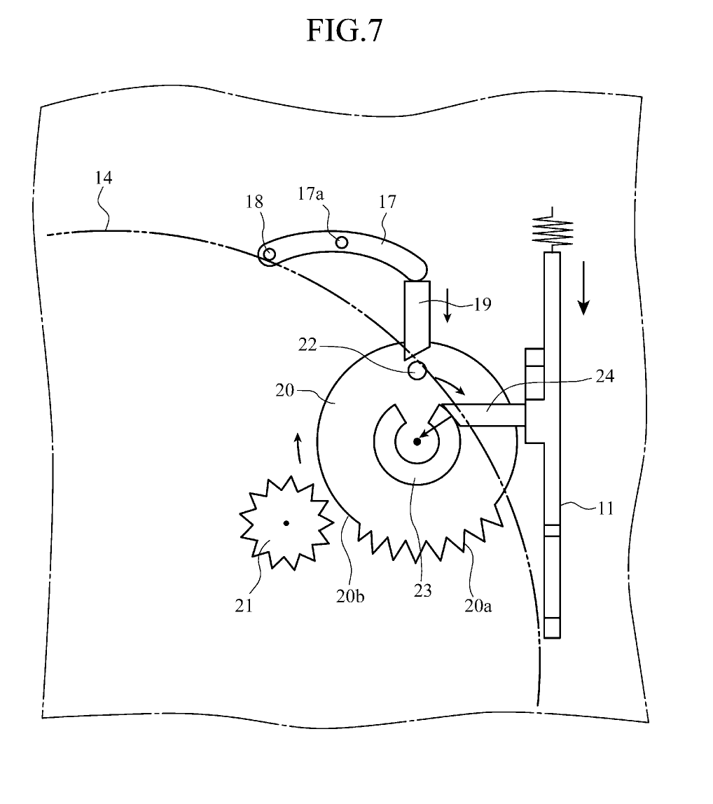

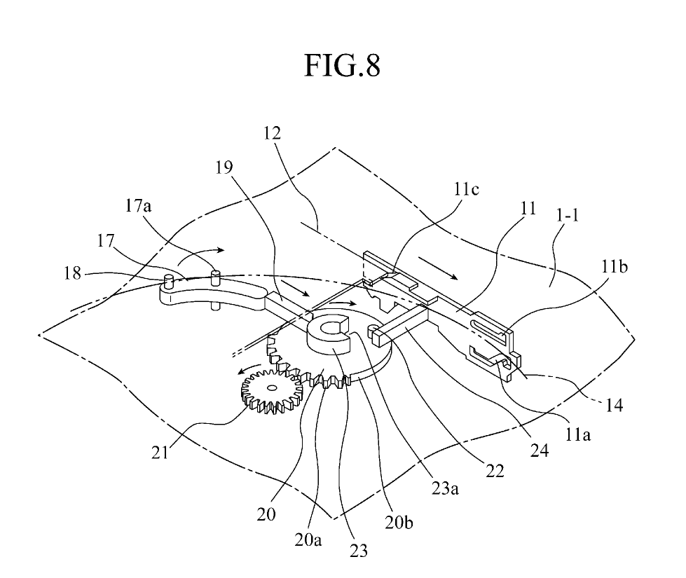

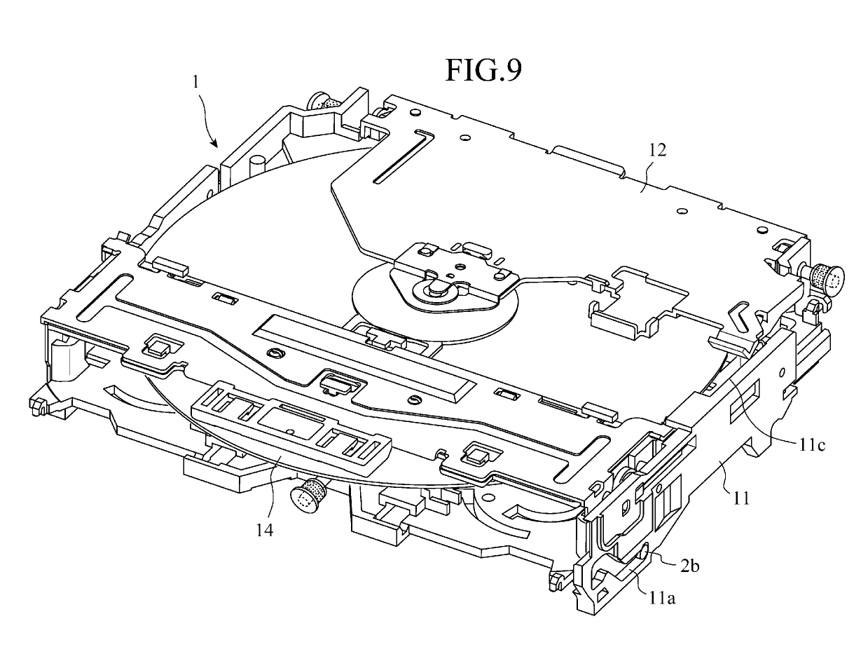

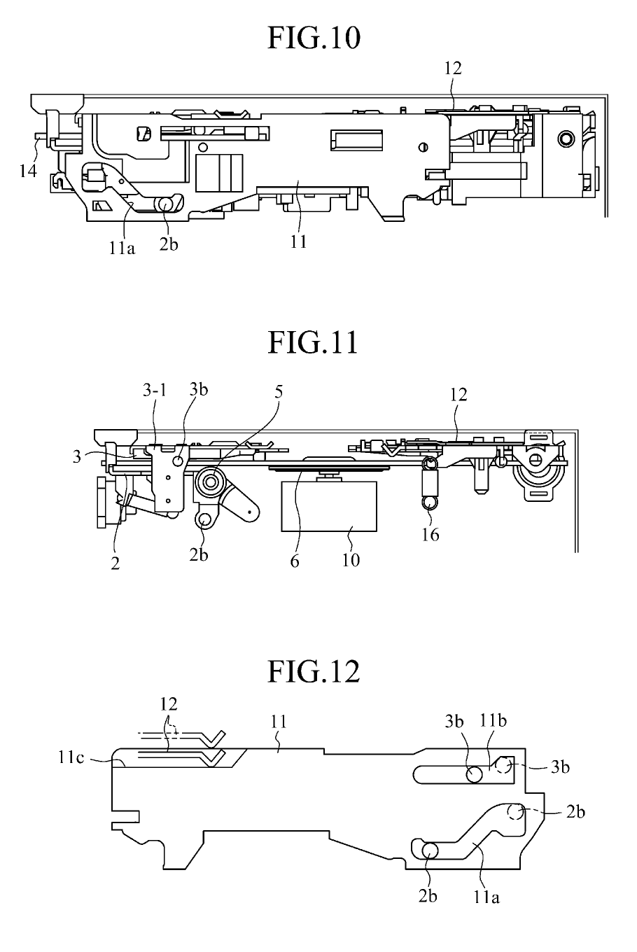

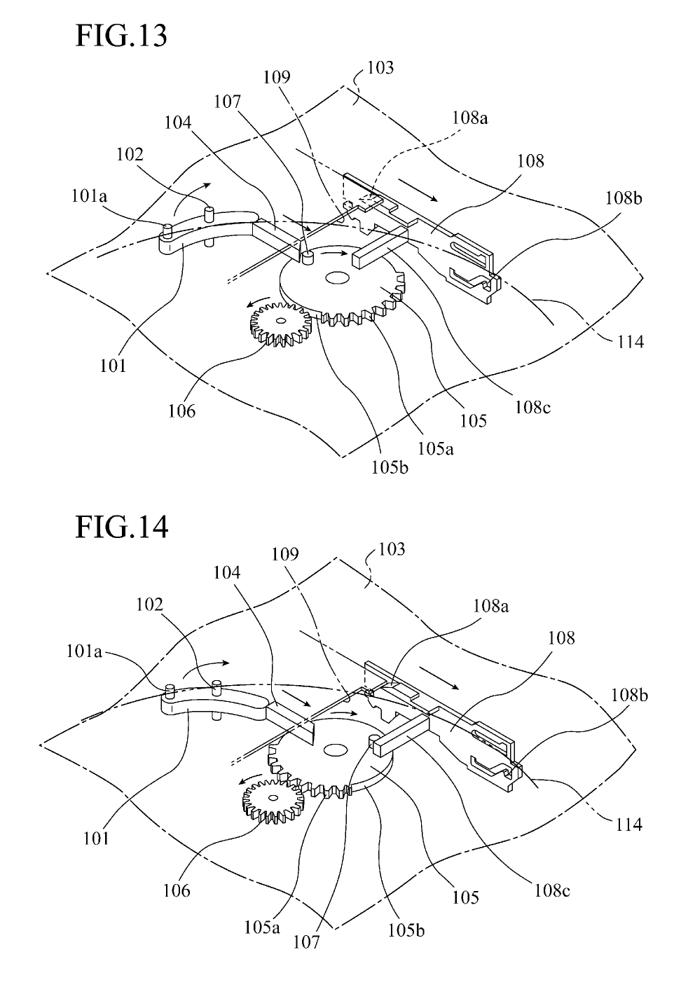

A disk playback unit in accordance with the first embodiment of the present invention will now be discussed with reference to the drawings. FIG. 1 is an exploded perspective view of a disk playback unit in accordance with the first embodiment of the present invention; FIG. 2 is a plan view of main parts thereof before a disk is loaded; FIG. 3 is a perspective view showing a playback unit in a loading state of the disk; FIG. 4 is a right-hand side view of the playback unit, and a perspective view showing a loading state to the playback unit, and also FIG. 4 is a side view of FIG. 3; FIG. 5 is a side view showing the unit with a slide member removed therefrom in FIG. 4; FIG. 6 is a perspective view of the main parts thereof showing a state where a loaded disk is abutted against a disk detecting member; FIG. 7 is an enlarged plan view of FIG. 6; FIG. 8 is a perspective view of the main parts showing a state where a disk is loaded in a predetermined position; FIG. 9 is a perspective view showing the playback unit in a state where the disk loading is completed; FIG. 10 is a right-hand side view of the playback unit; FIG. 11 is a side view showing the unit with a slide member removed therefrom in FIG. 10; and FIG. 12 is a front view showing the slide member viewed from the inside of the unit along the line A-A of FIG. 3.

As shown in FIG. 1 to FIG. 5, a board 1-1 constituting a playback unit 1 is provided with a roller support member 2, a disk guide 3, a turntable 6, a slide member 11 for switching the modes of a disk loading stand-by state and a disk playback state, a rotation body 20 for moving the slide member 11, and other components.

The roller support member 2 is rotatably fixed to the playback unit 1 by passing a right and a left support shafts 1a, 1a provided on the playback unit 1 through mounting holes 2a, 2a (depicted by partially cutout portions in FIG. 1) provided through a pair of right and left lugs 2-1, 2-1 turned-out toward the back of a plate-shaped body, respectively. Also, the roller support member 2 includes, on the right and left sides thereof, pins 2b, 2b each fitting along a carrier roller traveling cam groove 11a (see FIG. 12) of the slide member 11 provided on each side of the playback unit 1. A roller (disk carrier roller) 5 is pivotally supported to be rotatable at both ends thereof by the roller support member 2, and is urged by a spring 9 (see FIG. 5) so as to be pressed against the backside of the disk guide 3.

The disk guide 3 includes downward guide lugs 3-1, 3-1 on both the right and left sides, and is vertically movably attached to the playback unit 1 by inserting pins 3a, 3a provided on the inner faces of the guide lugs 3-1, 3-1 in grooves 1b extending in an upstanding direction that are prepared on both the right and left sides of the playback unit 1, respectively. Moreover, pins 3b, 3b (left pin is not shown) fitting along the disk guide traveling cam groove 11b (see FIG. 12) of the slide member 11 are provided on the outer face of the guide lugs 3-1, 3-1, respectively. The turntable 6 is disposed at the center of the interior of the board 1-1; a spindle motor 10 (see FIG. 5) for rotating and driving the turntable 6 and an optical pickup 8 for reading signals recorded on the disk 14 are provided in the vicinity thereof.

The slide member 11 is provided movably back and forth on each side of the playback unit 1 (FIG. 3 shows only one side), and the carrier roller traveling cam groove 11a and the disk guide traveling cam groove lib as shown in FIG. 12 are provided on the inner face of the forward portion thereof. Furthermore, a shoulder 11c for releasing restraint laid on a clamp member 12 is provided on the top face of the backward portion of the slide member; when the shoulder 11c comes to a position corresponding to the clamp member 12, the clamp member 12 is lowered onto the turntable 6 by the urging force of an urging member 16 (see FIG. 5) to press and clamp the disk 14 on the turntable 6.

Here, as shown in FIG. 6, FIG. 8, and FIG. 12, a moving means for downwardly moving the carrier roller 5 and the disk guide 3 in respective amounts of travel which are different from each other is composed of: the slide member 11; the disk guide travelling cam groove 11b and the carrier roller travelling cam groove 11a that are formed through the slide member 11; the pins 3b, 3b that are provided on the disk guide 3 and act on the disk guide travelling cam groove 11b; and the pins 2b, 2b that are provided on the roller support member 2 and act on the carrier roller travelling cam groove 11a.

As shown in FIG. 6 to FIG. 8, the disk detecting member 17 is pivotally supported to be rotatable about the shaft 17a in the middle portion thereof on the board 1-1, is provided on the top face on one end thereof a pin 18 against which the peripheral surface of a disk abuts, and abuts the rear end of the driving force transmitting member 19 on the end face of the other end thereof. The driving force transmitting member 19 is urged in the direction opposite to an arrow by an urging member (not shown).

Further, as shown in FIG. 6 to FIG. 8, a tooth-lacking gear 20a is prepared around the rotation body 20 provided rotatably on the board 1-1; a normally rotating drive gear 21 in which the tooth-lacking gear 20a engages and disengages according to the rotation of the rotation body 20 is provided on the board 1-1. A pin 22 is provided on the surface of the rotation body 20 so as to be situated on the travel line of the driving force transmitting member 19 in the disk loading stand-by state. Further, a cutaway section 23a cut out in an axial direction thereof is provided coaxially with a tubular body 23 on the surface of the rotation body 20.

On the other hand, an arm section 24 of which the tip abuts against the peripheral surface of the tubular body 23 is formed on the slide member 11; the arm section 24 is abutted against the surface of the tubular body 23 on the upper side of the cutaway section 23a in the direction of rotation of the tubular body 23; an abutment face of the arm section 24 abutting against the surface of the tubular body is formed with an inclined face. For this reason, it is arranged that the moving force of the slide member 11 works on the center of the rotation body 20 through the arm section 24 and the tubular body 23, and the slide member 11 cannot be moved as long as the cutaway section 23a does not oppose the arm section 24 by the rotation of the rotation body 20.

Next, a description will be given of the operation thereof.

As shown in FIG. 1 to FIG. 5, the roller support member 2 is rotated and urged by the spring 9 in the direction indicated by arrow B (see FIG. 5) with a support shaft la (see FIG. 1) as a fulcrum, and the carrier roller 5 is urged toward the back side of the disk guide 3. Further, the disk guide 3 is forced upwardly by the carrier roller 5, and moved in the direction indicated by an arrow C (see FIG. 4) along the groove 1b (see FIG. 1) to be located thereat.

In such a disk loading stand-by state, when a disk 14 is loaded, a detection signal from a detecting member (not shown) representing the detection of the loading closes a switch of a motor circuit (not shown) , the motor 10 rotates the carrier roller 5 by the driving force thereof, and the disk 14 is pinched between the carrier roller 5 and the disk guide 3 to be carried to the interior of the device by the roller.

As shown in FIG. 6, the loaded disk 14 pushes the pin 17a with the peripheral surface thereof to rotate the disk detecting member 17 in the direction indicated by the arrow, and moves the driving force transmitting member 19 in the direction indicated by the arrow with one end of the disk detecting member. The driving force transmitting member 19 thus moved pushes the pin 22 with the inclined face of the tip thereof, to thereby rotate the rotation body 20 in the direction indicated by the arrow. Consequently, a gear-lacking section 20b is moved off from the position where the gear-lacking section opposes the drive gear 21, and the gear section 20a following the gear-lacking section 20b meshes with the drive gear 21. Thereafter, the rotation body 20 is driven by the drive gear 21, and continues the rotation in the direction indicated by the arrow. By the rotation of the rotation body 20, the cutaway section 23a of the tubular body 23 is located in the position where the cutaway section opposes the arm section 24 of the slide member 11, the arm section 24 is released from the abutting engagement thereof with the peripheral surface of the tubular body, and the slide member 11 is pushed by the pin 22 of the rotation body 20 on which the arm section 24 works, to thus be moved in the direction indicated by the arrow.

Further, as the slide member 11 is moved to a terminal, the clamp member 12 that is restrained from downwardly rotating on the top face of the slide member 11 as shown in FIG. 12 corresponds to the shoulder 11c located on the top face of the slide member, to thereby be released from the restraint, and is lowered by the urging force of the urging member 16 and is downwardly rotated to thereby press and hold the disk 14 on the top of the turntable 6 as shown in FIG. 8 to FIG. 11.

Furthermore, the roller support member 2 receives a rotation force by the carrier roller travelling cam groove 11a to be lowered, and also the disk guide 3 receives a rotation force by the disk guide travelling cam groove 11b to be lowered in an amount of movement which is different from that of the roller support member 2 and simultaneously be moved in the horizontal direction by a distance corresponding to the clearance between the pin 3a and the groove 1b.

In this case, the carrier roller 5 and the disk guide 3 are downwardly moved in respective amounts of movement which are different from each other because of the difference in form between the carrier roller travelling cam groove 11a and the disk guide travelling cam groove 11b. As a result, there are formed respective clearances between the top board (not shown) of the device main body and the disk guide 3, between the disk guide 3 and the disk 14, and between the disk 14 and the carrier roller 5; thus, there is secured vibration isolation between the top board of the device main body and the disk guide 3. Moreover, the disk 14 is prevented from coming in contact with the disk guide 3 and the carrier roller 5 between the disk guide 3 and the disk 14, and between the disk 14 and the carrier roller 5 during playback.

Meanwhile, even if a moving force is exerted on the slide member 11 by some impact in a disk loading stand-by state, e.g., the moving force exerted on the slide member 11 acts from the arm section 24 toward the center of the rotation body 20 through the tubular body 23, and thus the slide member 11 cannot accidentally move as long as the rotation body 20 does not rotate.

As discussed above, in accordance with the first embodiment, it is arranged that the disk device includes: the rotation body to be driven by the disk detecting member to move the slide member; the tubular body provided coaxially on the surface of the rotation body and having an axially cutaway section; and the arm section provided on the slide member and causing the moving force exerted on the slide member to act on the center of the rotation body when abutted against the peripheral surface of the tubular body. Thus, as long as the cutaway section does not oppose the arm section due to the rotation of the rotation body, the moving force exerted on the slide member works from the arm section toward the center of the rotation body through the tubular body. Therefore, no slide member is moved even if an impact force produced by vibrations or the like is exerted thereon. In such a way, there is an advantageous effect such that the modes of the disk loading stand-by state and the disk playback state are switched by an accidental movement of the slide member can be positively prevented.

Furthermore, it is arranged that the arm section is abutted against the surface of the tubular body on the upper side of the cutaway section in the direction of rotation of the tubular body. Thus, there are advantageous effects of certainly preventing the slide member from being accidentally moved in an event where the member is subjected to an impact force such as vibrations or the like, and also of smoothly switching the modes from the disk loading stand-by state to the disk playback state during normal operation.

Further, it is arranged that the arm section have the abutment face of the arm section abutting against the surface of the tubular body is formed with an inclined face. Thus, the arm section makes line contact with the face of the tubular body, which can transmit the moving force of the slide member to the tubular body with stability. Consequently, there is an advantageous effect that a mode switching due to an accidental movement of the slide member can be positively prevented.

### INDUSTRIAL APPLICABILITY

According to the disk device of the present invention, even if the impact force due to vibrations or the like is exerted on the slide member, the disk device with a simple structure can positively prevent an event such that the modes from the disk loading stand-by state to the disk playback state are switched, for example, by an accidental movement of the slide member. Thus, it is suitable for use in a disk device and so on that switch the modes of the disk loading stand-by state and the disk playback state by the movement of a slide member.

1. A disk device switching between a disk loading stand-by mode and a disk playback mode by the movement of a slide member, the disk device comprising:
a disk detecting member to be pushed and moved by a disk;
a rotation body to be driven by the movement of the disk detecting member to move the slide member;
a tubular body provided coaxially on the surface of the rotation body and having an axially cutaway section; and
an arm section provided on the slide member to be abutted against the peripheral surface of the tubular body such that a moving force exerted on the slide member is acted on the center of the rotation body.

2. disk device according to claim 1, wherein the arm section is abutted against the surface of the tubular body on the upper side of the cutaway section in the direction of rotation of the tubular body.

3. The disk device according to claim 1, wherein an abutment face of the arm section abutting against the surface of the tubular body is formed with an inclined face.

4. The disk device according to claim 1, wherein when an impact force exerted on the slide member is arranged to be directed toward the center of rotary components, even if some impact is delivered to the slide member, the rotation body is not rotated to disable the slide member to be moved, thus preventing a switch between modes due to the impact and maintaining a disk clamping state.
